(19) United States
(12) Patent Application Publication
(10) Pub. No.: US 2018/0367877 A1
(43) Pub. Date: Dec. 20, 2018

(54) LOUDSPEAKER BOX FOR BICYCLE

(71) Applicant: Hong Kong Parkly Technology Limited, Hong Kong (HK)

(72) Inventor: Shi Jie Xiong, Hong Kong (HK)

(21) Appl. No.: 15/712,511

(22) Filed: Sep. 22, 2017

(30) Foreign Application Priority Data
Jun. 20, 2017 (CN) 201720725270.8

(51) Int. Cl. H04R 1/02; B62J 6/00

(52) U.S. Cl. CPC H04R 1/028; B62J 2099/0006; B62J 6/001; H04R 1/026

(57) ABSTRACT

Disclosed is a loudspeaker box for bicycle, which includes a housing provided thereon with an illumination unit, a key unit, a loudspeaker, a memory card interface, and a charging and discharging connector, and provided therein with a circuit board and a battery. The circuit board includes a main control unit, a power amplifier unit, and a charging and discharging module which includes a charging and discharging chip, and a charging end of the charging and discharging chip is electrically connected to the drain of a first MOS tube; the source of the first MOS tube is electrically connected to a voltage end of a charging and discharging connector; a discharging end of the charging and discharging chip is electrically connected to the drain of the second MOS tube; and the source of the second MOS tube is electrically connected to the voltage end of the charging and discharging connector.

### CROSS-REFERENCE TO RELATED APPLICATIONS

The present invention claims the benefit of Chinese Patent Application No. 201720725270.8, filed on Jun. 20, 2017, which is hereby incorporated by reference as its entirety.

### FIELD OF THE INVENTION

The present invention relates to a loudspeaker, and in particular, to a loudspeaker box for bicycle.

### BACKGROUND OF THE INVENTION

A loudspeaker box for bicycle is a common equipment of a rider enthusiast, is only used as a loudspeaker box and has the following defects:

1. the loudspeaker box for bicycle has a single function and lacks an illumination function;

2. although a battery is included, the battery only supplies power to the inner part of the loudspeaker box and cannot output electric energy to the external electronic device;

3. during a using process, a change of the output voltage of the battery affects a working state of the power amplifier unit, and further affects the entire performance of the loudspeaker box;

4. when a sound source is interfered or there is a short circuit of the circuit board, a relatively great peak in an audio signal is amplified by the power amplifier unit, and may easily damage the loudspeaker and further affect stability and the use life of the loudspeaker box;

5. the loudspeaker box needs to be fixed on a handlebar of a bicycle, and needs to be configured with relatively complex structures to perform angle changes and orientation, which has a relatively high cost and is hard to be realized.

### SUMMARY OF THE INVENTION

A technical problem to be resolved by the present invention is to provide a loudspeaker box for bicycle with functions of audio, illumination, and a movable power source, and can realize charging and discharging functions by only using an interface.

To resolve the foregoing technical problems, the present invention provides the following technical solutions.

A loudspeaker box for bicycle includes a housing and a support disposed on the housing; wherein the housing is provided thereon with an illumination unit, a key unit, a loudspeaker, a memory card interface, and a charging and discharging connector; the housing is provided therein with a circuit board and a battery, and the circuit board is provided thereon with a main control unit; the illumination unit, the key unit, and the memory card interface are respectively electrically connected to the main control unit; the key unit is used to input a control instruction to the main control unit; the illumination unit is used to execute an instruction of the main control unit for emitting light; the main control unit uses a memory card interface to receive an audio signal; a power amplifier unit, wherein the power amplifier unit is electrically connected between the main control unit and the loudspeaker, and the main control unit amplifies the received audio signal by using the power amplifier unit and loads the audio signal on the loudspeaker; a charging and discharging module, wherein the charging and discharging module includes a charging and discharging chip; and a conversion end of the charging and discharging chip is electrically connected to a positive electrode of a battery; a charging end of the charging and discharging chip is electrically connected to the drain of the first MOS tube; the source of the first MOS tube is electrically connected to the voltage end of the charging and discharging connector; the gate of the first MOS tube is electrically connected to a collector of a first NPN tube by means of a first divider resistor; the gate of the first MOS tube is further connected to the voltage end of the charging and discharging connector by means of a first pull-up resistor; the emitter of the first NPN tube is grounded, and the base of the first NPN tube is connected to the voltage end of the charging and discharging connector by means of a second pull-up resistor; the base of the first NPN tube is connected to the collector of the second NPN tube; the emitter of the second NPN tube is grounded, and the base of the second NPN tube is electrically connected to the main control unit; a discharging end of the charging and discharging chip is electrically connected to the drain of the second MOS tube; the source of the second MOS tube is electrically connected to the voltage end of the charging and discharging connector; the gate of the second MOS tube is electrically connected to the collector of a third NPN tube; the emitter of the third NPN tube is grounded, and the base of the third NPN tube is electrically connected to the main control unit; the voltage end of the charging and discharging connector is electrically connected to the main control unit by means of the first sampling resistor; when the main control unit detects, by using the first sampling resistor, that the voltage end of the charging and discharging connector is at a high level, the main control unit sends a low level to the base of the second NPN tube and the base of the third NPN tube; to cut off the third NPN tube, and the second MOS tube is cut off because the gate has no voltage; meanwhile, the second NPN tube is cut off; the base of the first NPN tube generates a voltage because of the second pull-up resistor, and the first NPN tube is conducted to enable the first MOS tube to be subsequently conducted because the gate generates a voltage; the voltage of the voltage end of the charging and discharging connector is transmitted to the charging end of the charging and discharging chip via the first MOS tube; the conversion end of the charging and discharging chip charges the battery; when the main control unit detects by using the first sampling resistor that the voltage end of the charging and discharging connector is at a low level and receives that a mark output by the key unit is a control instruction for discharging, the main control unit sends a high level to the base of the second NPN tube and the base of the third NPN tube; the second NPN tube is conducted and pulls down the voltage of the base of the first NPN tube; the first NPN tube is cut off to enable the first MOS tube to be subsequently cut off because the gate has no voltage; meanwhile, the third NPN tube is conducted to enable the second MOS tube to be subsequently conducted because the gate generates a voltage; the charging and discharging chip transmits the voltage of the positive electrode of the battery to the voltage end of the charging and discharging connector via the second MOS tube; the voltage end is used to provide a power source to an external electronic device.

In the loudspeaker box for bicycle disclosed in the present invention, besides the audio function and the illumination function, by combining a cooperation function of the main control unit and the charging and discharging module, a charging and discharging connector can be used to realize charging and discharging, especially for flexible control of the first MOS tube and the second MOS tube, effectively realizing conversion of a charging process and a discharging process, enabling the loudspeaker to have a function of a movable power source, and facilitating using as a standby power source during a riding process. In addition, under the functions of the first NPN tube, the second NPN tube, and the third NPN tube, the main control unit may synchronously output a same level to the second NPN tube and the third NPN tube, and the beneficial effects are to prevent disorder due to control of too many levels, especially in an application, only one IO interface is used to control the two MOS tubes at the same time, effectively saving IO interfaces.

### BRIEF DESCRIPTION OF THE DRAWINGS

FIG. 1 is a front view of a loudspeaker box for bicycle of the present invention;

FIG. 2 is a side view of a loudspeaker box for bicycle of the present invention;

FIG. 3 is a top view of a loudspeaker box for bicycle of the present invention;

FIG. 4 is a schematic structural diagram of a support;

FIG. 5 is a circuit block diagram of a loudspeaker box for bicycle of the present invention;

FIG. 6 is a circuit principle diagram of a main control unit;

FIG. 7 is a circuit principle of a charging and discharging module;

FIG. 8 is a principle diagram of a voltage stabilizing circuit; and

FIG. 9 is a principle diagram of a loudspeaker protection unit.

### DETAILED DESCRIPTION OF ILLUSTRATED EMBODIMENTS

The present invention is described in detail below by combining the accompany drawings and the embodiments.

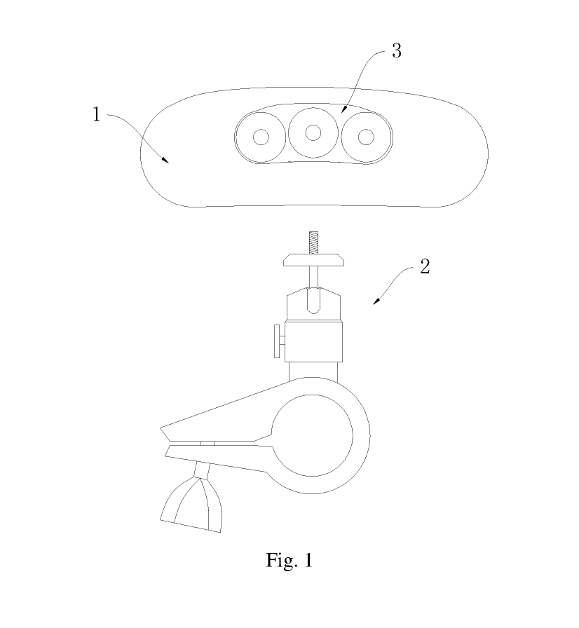

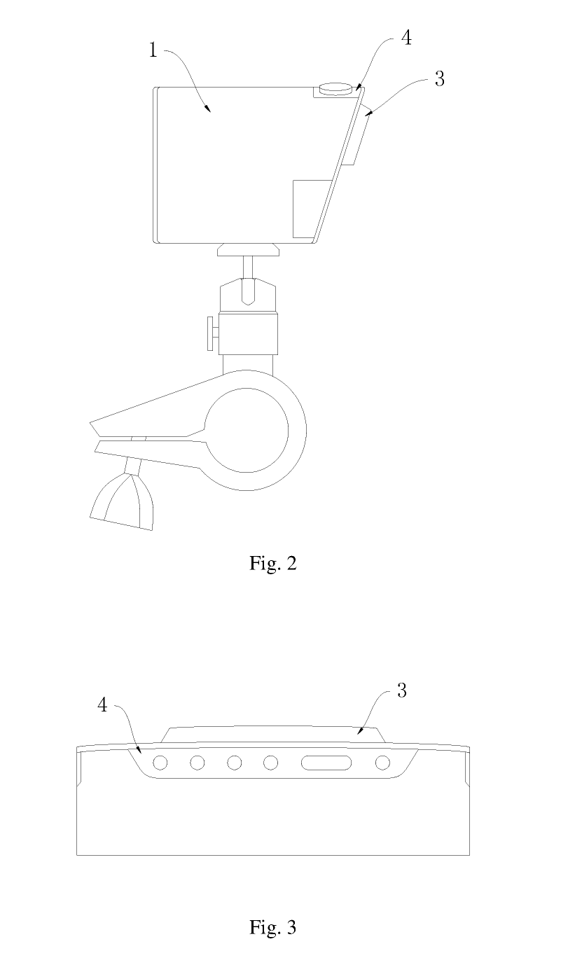

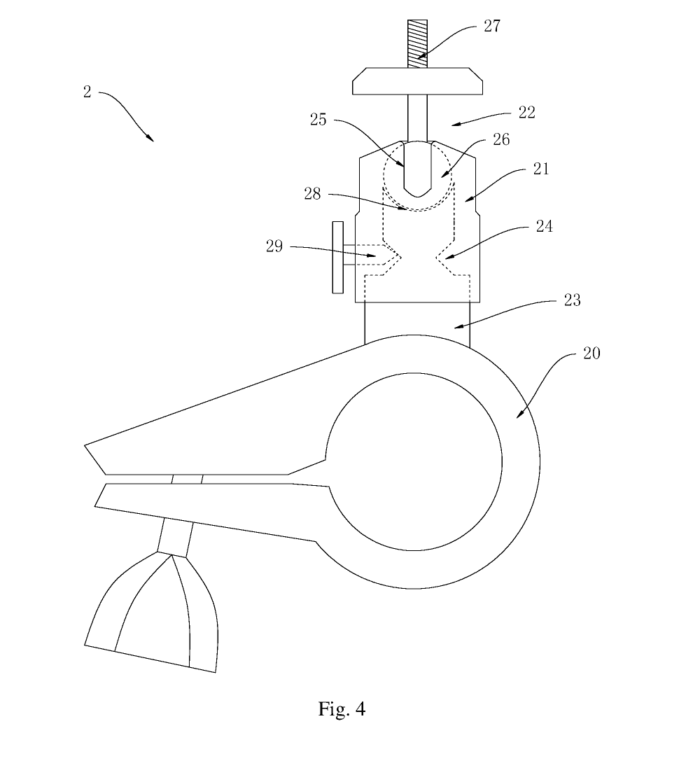

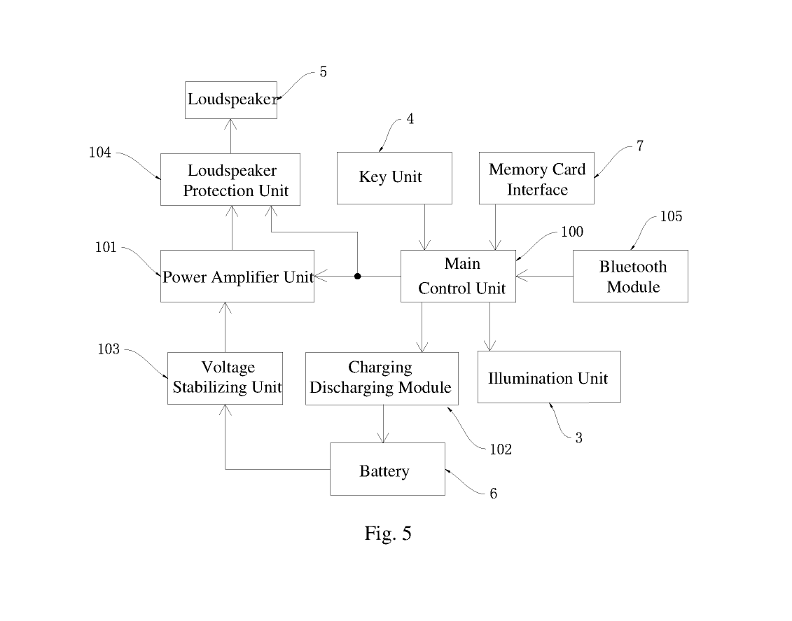

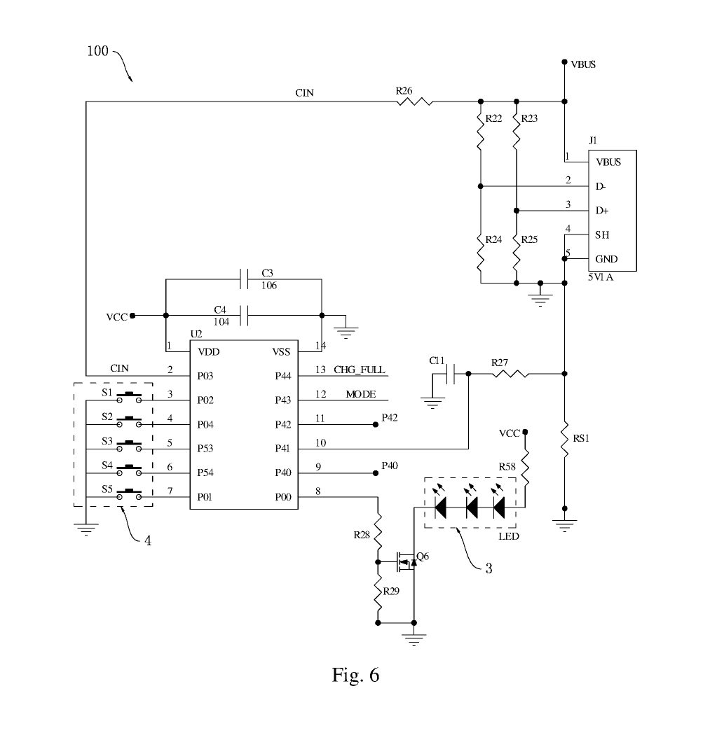

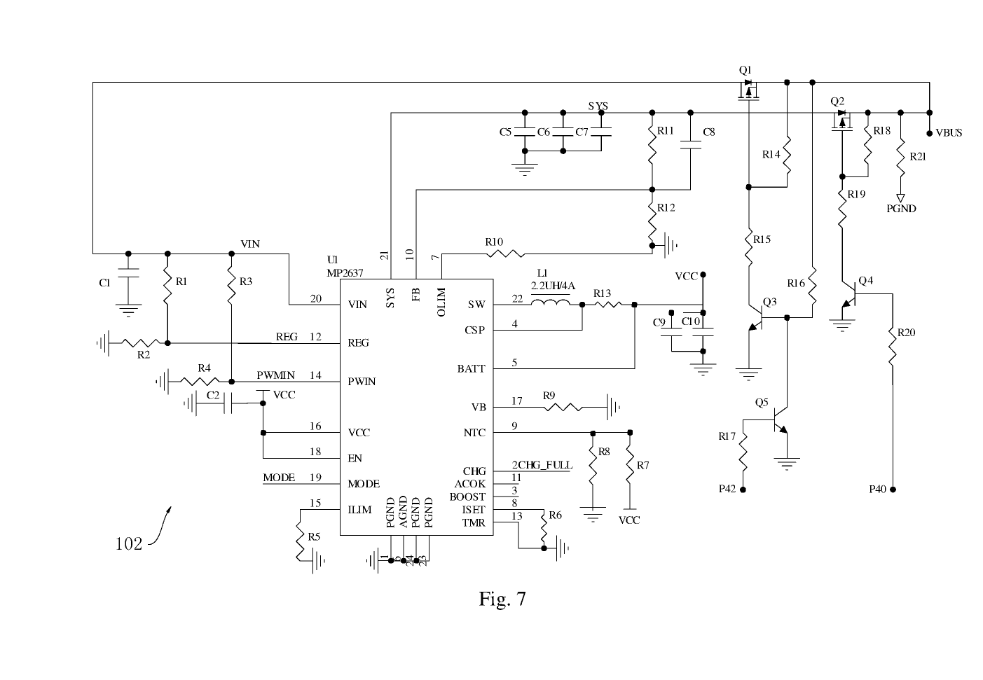

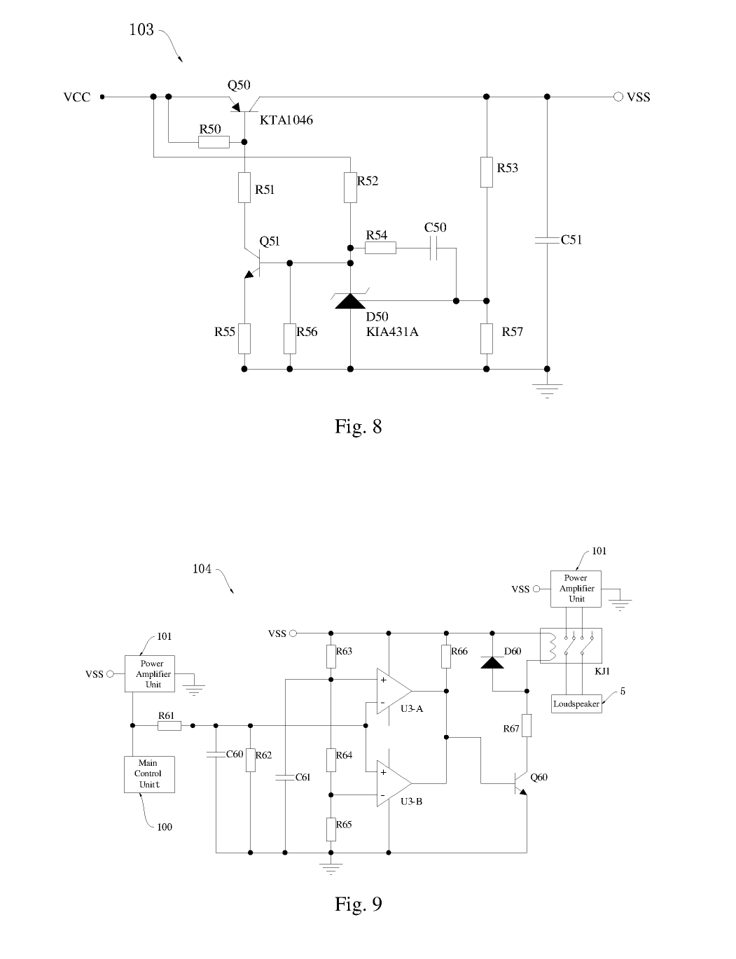

The present invention discloses a loudspeaker box for bicycle, as shown in FIG. 1 to FIG. 9, including a housing 1 and a support 2 disposed on the housing 1, wherein the housing 1 is provided thereon with an illumination unit 3, a key unit 4, a loudspeaker 5, a memory card interface 7, and a charging and discharging connector J1; the housing 1 is provided therein with a circuit board and a battery 6, and the circuit board is provided thereon with a main control unit 100, a power amplifier unit 101 and a charging and discharging module 102.

The illumination unit 3, the key unit 4, and the memory card interface 7 are respectively electrically connected to the main control unit 100; the key unit 4 is used to input a control instruction to the main control unit 100; the illumination unit 3 is used to execute the instruction of the main control unit 100 for emitting light, and the main control unit 100 uses the memory card interface 7 to receive an audio signal.

The power amplifier unit 101 is electrically connected between the main control unit 100 and the loudspeaker 5, and the main control unit 100 amplifies the received audio signal by using the power amplifier unit 101 and loads the audio signal on the loudspeaker 5.

The charging and discharging module 102 includes a charging and discharging chip U1; and a conversion end SW of the charging and discharging chip U1 is electrically connected to a positive electrode VCC of a battery 6; a charging end VIN of the charging and discharging chip U1 is electrically connected to the drain of the first MOS tube Q1; the source of the first MOS tube Q1 is electrically connected to the voltage end VBUS of the charging and discharging connector J1; the gate of the first MOS tube Q1 is electrically connected to a collector of a first NPN tube Q3 by means of a first divider resistor R15; the gate of the first MOS tube Q1 is further connected to the voltage end VBUS of the charging and discharging connector J1 by means of a first pull-up resistor R14; the emitter of the first NPN tube Q3 is grounded, and the base of the first NPN tube Q3 is connected to the voltage end VBUS of the charging and discharging connector J1 by means of a second pull-up resistor R16; the base of the first NPN tube Q3 is connected to the collector of the second NPN tube Q5; the emitter of the second NPN tube Q5 is grounded, and the base of the second NPN tube is electrically connected to the main control unit 100; a discharging end SYS of the charging and discharging chip U1 is electrically connected to the drain of the second MOS tube Q2; the source of the second MOS tube Q2 is electrically connected to the voltage end VBUS of the charging and discharging connector J1; the gate of the second MOS tube Q2 is electrically connected to the collector of a third NPN tube Q4; the emitter of the third NPN tube Q4 is grounded, and the base of the third NPN tube Q4 is electrically connected to the main control unit 100; the voltage end VBUS of the charging and discharging connector J1 is electrically connected to the main control unit 100 by means of the first sampling resistor R26.

When the main control unit 100 detects by using the first sampling resistor R26 that the voltage end VBUS of the charging and discharging connector J1 is at a high level, the main control unit 100 sends a low level to the base of the second NPN tube Q5 and the base of the third NPN tube Q4; to cut off the third NPN tube Q4, and the second MOS tube Q2 is cut off because the gate has no voltage; meanwhile, the second NPN tube Q5 is cut off; the base of the first NPN tube Q3 generates a voltage because of the second pull-up resistor R16, and the first NPN tube Q3 is conducted to enable the first MOS tube Q1 to be subsequently conducted because the gate generates a voltage; the voltage of the voltage end VBUS of the charging and discharging connector J1 is transmitted to the charging end of the charging and discharging chip U1 via the first MOS tube Q1; the conversion end SW of the charging and discharging chip U1 charges the battery 6.

When the main control unit 100 detects by using the first sampling resistor R26 that the voltage end VBUS of the charging and discharging connector J1 is at a low level and receives that a mark output by the key unit 4 is a control instruction for discharging, the main control unit 100 sends a high level to the base of the second NPN tube Q5 and the base of the third NPN tube Q4; the second NPN tube Q5 is conducted and pulls down the voltage of the base of the first NPN tube Q3; the first NPN tube Q3 is cut off to enable the first MOS tube Q1 to be cut off because the gate has no voltage; meanwhile, the third NPN tube Q4 is conducted to enable the second MOS tube Q2 to be conducted because the gate generates a voltage; the charging and discharging chip U1 transmits the voltage of the positive electrode VCC of the battery 6 to the voltage end VBUS of the charging and discharging connector J1 via the second MOS tube Q2; the voltage end VBUS is used to provide a power source to an external electronic device. Further, the charging and discharging chip U1 is a charging and discharging chip with a model number of MP2637.

In the loudspeaker box for bicycle disclosed in the present invention, besides the audio function and the illumination function, by combining a cooperation function of the main control unit 100 and the charging and discharging module 102, a charging and discharging connector J1 can be used to realize charging and discharging, especially for flexible control of the first MOS tube Q1 and the second MOS tube Q2, effectively realizing conversion of a charging process and a discharging process, enabling the loudspeaker to have a function of a movable power source, and facilitating using as a standby power source during a riding process. In addition, under the functions of the first NPN tube Q3, the second NPN tube Q5, and the third NPN tube Q4, the main control unit 100 may synchronously output a same level to the second NPN tube Q5 and the third NPN tube Q4, and the beneficial effects are to prevent disorder due to control of too many levels, especially in an application, only one IO interface is used to control the two MOS tubes at the same time, effectively saving IO interfaces.

Further, to ensure that the power amplifier unit 101 obtains a stable power supply voltage, a voltage stabilizing circuit 103 is provided between the battery 6 and the power amplifier unit 101; the voltage stabilizing circuit 103 includes a first PNP tube Q50, a fourth NPN tube Q51, and a voltage-regulator tube D50; the voltage-regulator tube D50 is a voltage-regulator tube of a KTA431A type, and the emitter of the first PNP tube Q50 is connected to the positive electrode VCC of the battery 6; the collector of the first PNP tube Q50 is used as an output end of the voltage stabilizing circuit 103 for supplying power for the power amplifier unit 101; the collector of the fourth NPN tube Q51 is connected to the positive electrode VCC of the battery 6 via a first current-limiting resistor R51 and a second current-limiting resistor R50 that are sequentially connected in series; the emitter of the fourth NPN tube Q51 is grounded via the third current-limiting resistor R55; a connection point of the first current-limiting resistor R51 and the second current-limiting resistor R50 is connected to the base of the first PNP tube Q50; the cathode of the voltage-regulator tube D50 is connected to the positive electrode VCC of the battery 6 via the second divider resistor R52; the cathode of the voltage-regulator tube D50 is connected to the base of the fourth NPN tube Q51, and the base of the fourth NPN tube Q51 is grounded via the third divider resistor R56; the anode of the voltage-regulator tube D50 is grounded, and the collector of the first PNP tube Q50 are grounded via a fourth divider resistor R53 and a fifth divider resistor R57 that are sequentially connected in series; and a connection point of the fourth divider resistor R53 and the fifth divider resistor R57 is connected to a reference electrode of the voltage-regulator tube D50.

The positive electrode VCC, the second divider resistor R52, and the third divider resistor R56 of the battery 6 and the ground compose a loop; the fourth NPN tube Q51 is conducted, and the first PNP tube Q50 is subsequently conducted; a voltage between the fourth divider resistor R53 and the fifth divider resistor R57 is transmitted to a reference electrode of the voltage-regulator tube D50; the output voltage Vout of the voltage stabilizing circuit 103=2.5V*(1+the fourth divider resistor R53/the fifth divider resistor R57), and the output voltage Vout of the voltage stabilizing circuit 103 supplies power for the power amplifier unit 101.

Features of the KTA431A type voltage-regulator tube is fully used in this embodiment. The output voltage of the voltage stabilizing circuit 103 is stabilized to a preset value, and a value of the output voltage of the voltage stabilizing circuit 103 may be realized by setting resistance values of the fourth divider resistor R53 and the fifth divider resistor R57. In this embodiment, a first PNP tube Q50 and a fourth NPN tube Q51 are specially set. The function is that when the battery power is too low, the voltage on which voltage division is performed by the second divider resistor R52 and the third divider resistor R56 cannot start the fourth NPN tube Q51, so that the first PNP tube Q50 is in a closed state, avoiding that the power amplifier unit is subsequently operated in a low voltage state.

During actual application to avoid a relatively great peak value in the audio signal from damaging the loudspeaker, the present invention further includes a loudspeaker protection unit 104, the loudspeaker protection unit 104 includes a first comparator U3-A, a second comparator U3-B, and a relay KJ1; a sixth divider resistor R63, a seventh divider resistor R64, and an eighth divider resistor R65 that are sequentially connected in series are provided between the output end VSS of the voltage stabilizing circuit 103 and the ground; the voltage of the connection point of the sixth divider resistor R63 and the seventh divider resistor R64 is transmitted to an in-phase end of the first comparator U3-A as a first reference voltage; the voltage of the connection point of the seventh divider resistor R64 and the eighth divider resistor R65 is transmitted to an out-phase end of the second comparator U3-B as a second reference voltage; the out-phase end of the first comparator U3-A and the in-phase end of the second comparator U3-B are connected to an input end of the power amplifier unit 101, to enable an audio signal of the input end of the power amplifier unit 101 to be transmitted to the out-phase end of the first comparator U3-A and the in-phase end of the second comparator U3-B; the output end of the first comparator U3-A and the output end of the second comparator U3-B are connected to the base of a fifth NPN tube Q60; the emitter of the fifth NPN tube Q60 is grounded, and the collector of the fifth NPN tube Q60 is connected to a coil of a relay KJ1 via a fourth current-limiting resistor R67; the other end of the relay KJ1 is connected to the output end VSS of the voltage stabilizing circuit 103; one side of a normal-open contact of the relay KJ1 is connected to the output end of the power amplifier unit 101; and the other side of the normal-open contact of the relay KJ1 is connected to the loudspeaker 5.

When the voltage of the audio signal of the input end of the power amplifier unit 101 is lower than the first reference voltage and is higher than the second reference voltage, the first comparator U3-A and the second comparator U3-B both output the high level, and the fifth NPN tube Q60 is subsequently conducted, to enable the coil of the relay KJ1 to be powered and the normal-open contact of the relay KJ1 to be picked up, and the power amplifier unit 101 is communicated with the loudspeaker 5.

When the voltage of the audio signal of the input end of the power amplifier unit 101 is higher than the first reference voltage, the first comparator U3-A outputs the low level, the fifth NPN tube Q60 is closed, and the power amplifier unit 101 is subsequently disconnected with the loudspeaker 5.

When the voltage of the audio signal of the input end of the power amplifier unit 101 is lower than the second reference voltage, the second comparator U3-B outputs the low level, the fifth NPN tube Q60 is closed, and the power amplifier unit 101 is subsequently disconnected with the loudspeaker 5.

During actual application, a method of lifting the level may be used to lift the audio signal of the input end of the amplifier unit 101 above 0V, combined with the loudspeaker protection unit 104, so that the voltage of the audio signal, whether too high or too low, can promptly disconnect the loudspeaker 5, which play a protective role.

Further, in order to save space of the circuit board, the relay KJ1 is a relay of a OMRON G6S-2F mini patch.

As an extension function, the circuit board is provided thereon with a Bluetooth module 105, the Bluetooth module 105 is electrically connected to the main control unit 100, and the Bluetooth module 105 is used to receive and send a Bluetooth signal.

As regards the specific structure of the support 2, the support 2 includes a clamp 20, an end cap 21, and a universal joint 22; a columnar bearing 23 is formed on the clamp 20, and a bowl-shaped recessed part 28 is formed on the top of the bearing 23; the end cap 21 is disposed on the bearing 23 in a covering manner, and the end cap 21 is provided thereon with a slot 25; the slot 25 extends from the top of the end cap 21 to the side, and the universal joint 22 includes a spherical part 26 and a connection rod 27; the spherical part 26 is disposed in the recessed part 28, the connection rod 27 penetrates through the end cap 21 and is screwed on the bottom of the housing 1; the side of the bearing 23 is provided with a V-shaped groove 24 surrounding the bearing 23; the side of the end cap 21 is provided and screwed with a top thread 29, and the end part of the top thread 29 is provided in the V-shaped groove 24; and the end part of the top thread 29 is abutted against an inner wall of one side of the V-shaped groove 24 close to the recessed part 28.

When the top thread 29 is screwed, the end part of the top thread 29 feeds to the V-shaped groove 24 so as to enable, by means of an abutting function of the end part of the top thread 29 and the inner wall of the V-shaped groove 24, the end cap 21 and the bearing 23 to move relatively, until the spherical part 26 is locked in the recessed part 28.

When the top thread 29 is screwed in a reverse direction, the end part of the top thread 29 is away from the V-shaped groove 24, and a gap is generated between the spherical part 26 and the recessed part 28, so that the universal joint 22 can move along the slot 25.

In this embodiment, by means of the interaction function of the end part of the top thread 29 and the inner wall of the V-shaped groove 24, effectively realizing locking and releasing of the bearing and the universal joint. The structure of the support is simple and easy to be realized, and has a relatively low product cost.

The loudspeaker box for bicycle disclosed in the present invention has an illumination function, an audio function, and a movable power source function, well satisfying user requirements, and only one interface is used to realize charging and discharging, reducing a quantity of interfaces of the loudspeaker box. In addition, the present invention has advantages of stable performance and low cost.

The foregoing descriptions are merely embodiments of the present invention, but are not intended to limit the present invention. Any modification, equivalent replacement, or improvement made within the technical scope of the present invention shall fall within the protection scope of the present invention.

What is claimed is:

1. A loudspeaker box for bicycle, comprising a housing (1) and a support (2) disposed on the housing (1), wherein the housing (1) is provided thereon with an illumination unit (3), a key unit (4), a loudspeaker (5), a memory card interface (7), and a charging and discharging connector (J1); the housing (1) is provided therein with a circuit board and a battery (6), and the circuit board is provided thereon with:
a main control unit (100), wherein the illumination unit (3), the key unit (4), and the memory card interface (7) are respectively electrically connected to the main control unit (100); the key unit (4) is used to input a control instruction to the main control unit (100); the illumination unit (3) is used to execute the instruction of the main control unit (100) for emitting light, and the main control unit (100) uses the memory card interface (7) to receive an audio signal;
a power amplifier unit (101), wherein the power amplifier unit (101) is electrically connected between the main control unit (100) and the loudspeaker (5), and the main control unit (100) amplifies the received audio signal by using the power amplifier unit (101) and loads the audio signal on the loudspeaker (5);
a charging and discharging module (102), wherein the charging and discharging module (102) comprises a charging and discharging chip (U1); and a conversion end (SW) of the charging and discharging chip (U1) is electrically connected to a positive electrode (VCC) of a battery (6); a charging end (VIN) of the charging and discharging chip (U1) is electrically connected to a drain of a first MOS tube (Q1); a source of the first MOS tube (Q1) is electrically connected to a voltage end (VBUS) of the charging and discharging connector (J1); a gate of the first MOS tube (Q1) is electrically connected to a collector of a first NPN tube (Q3) by means of a first divider resistor (R15); the gate of the first MOS tube (Q1) is connected to the voltage end (VBUS) of the charging and discharging connector (J1) by means of a first pull-up resistor (R14); an emitter of the first NPN tube (Q3) is grounded, and a base of the first NPN tube (Q3) is connected to the voltage end (VBUS) of the charging and discharging connector (J1) by means of a second pull-up resistor (R16); the base of the first NPN tube (Q3) is connected to a collector of the second NPN tube (Q5); an emitter of the second NPN tube (Q5) is grounded, and a base of the second NPN tube (Q5) is electrically connected to the main control unit (100); a discharging end (SYS) of the charging and discharging chip (U1) is electrically connected to a drain of the second MOS tube (Q2); a source of the second MOS tube (Q2) is electrically connected to the voltage end (VBUS) of the charging and discharging connector (J1); the gate of the second MOS tube (Q2) is electrically connected to the collector of a third NPN tube (Q4); the emitter of the third NPN tube (Q4) is grounded, and the base of the third NPN tube (Q4) is electrically connected to the main control unit (100); the voltage end (VBUS) of the charging and discharging connector (J1) is electrically connected to the main control unit (100) by means of a first sampling resistor (R26); wherein:
when the main control unit (100) detects by using the first sampling resistor (R26) that the voltage end (VBUS) of the charging and discharging connector (J1) is at a high level, the main control unit (100) outputs the low level to the base of the second NPN tube (Q5) and the base of the third NPN tube (Q4), to cut off the third NPN tube (Q4), and the second MOS tube (Q2) is cut off because the gate has no voltage; meanwhile, the second NPN tube (Q5) is cut off; the base of the first NPN tube (Q3) generates a voltage because of the second pull-up resistor (R16), and the first NPN tube (Q3) is conducted to enable the first MOS tube (Q1) to be conducted because the gate generates the voltage; the voltage of the voltage end (VBUS) of the charging and discharging connector (J1) is transmitted to the charging end of the charging and discharging chip (U1) via the first MOS tube (Q1); the conversion end (SW) of the charging and discharging chip (U1) charges the battery (6);
when the main control unit (100) detects by using the first sampling resistor (R26) that the voltage end (VBUS) of the charging and discharging connector (J1) is at a low level and receives that a mark output by the key unit (4) is a control instruction for discharging, the main control unit (100) sends a high level to the base of the second NPN tube (Q5) and the base of the third NPN tube (Q4); the second NPN tube (Q5) is conducted and pulls down the voltage of the base of the first NPN tube (Q3); the first NPN tube (Q3) is cut off to enable the first MOS tube (Q1) to be cut off because the gate has no voltage; meanwhile, the third NPN tube (Q4) is conducted to enable the second MOS tube (Q2) to be conducted because the gate generates a voltage; the charging and discharging chip (U1) transmits the voltage of the positive electrode (VCC) of the battery (6) to the voltage end (VBUS) of the charging and discharging connector (J1) via the second MOS tube (Q2); and the voltage end (VBUS) is used to provide a power source to an external electronic device.

2. The loudspeaker box for bicycle according to claim 1, wherein the charging and discharging chip (U1) is a charging and discharging chip with a model number of MP2637.

3. The loudspeaker box for bicycle according to claim 1, wherein a voltage stabilizing circuit (103) is provided between the battery (6) and the power amplifier unit (101); the voltage stabilizing circuit (103) comprises a first PNP tube (Q50), a fourth NPN tube (Q51), and a voltage-regulator tube (D50); the voltage-regulator tube (D50) is a voltage-regulator tube of a KTA431A type, and the emitter of the first PNP tube (Q50) is connected to the positive electrode (VCC) of the battery (6); the collector of the first PNP tube (Q50) is used as an output end of the voltage stabilizing circuit (103) for supplying power for the power amplifier unit (101); the collector of the fourth NPN tube (Q51) is connected to the positive electrode (VCC) of the battery (6) via a first current-limiting resistor (R51) and a second current-limiting resistor (R50) that are sequentially connected in series; the emitter of the fourth NPN tube (Q51) is grounded via the third current-limiting resistor (R55); a connection point of the first current-limiting resistor (R51) and the second current-limiting resistor (R50) is connected to the base of the first PNP tube (Q50); the cathode of the voltage-regulator tube (D50) is connected to the positive electrode (VCC) of the battery (6) via the second divider resistor (R52); the cathode of the voltage-regulator tube (D50) is connected to the base of the fourth NPN tube (Q51), and the base of the fourth NPN tube (Q51) is grounded via the third divider resistor (R56); the anode of the voltage-regulator tube (D50) is grounded, and the collector of the first PNP tube (Q50) is grounded via a fourth divider resistor (R53) and a fifth divider resistor (R57) that are sequentially connected in series; and a connection point of the fourth divider resistor (R53) and the fifth divider resistor (R57) is connected to a reference electrode of the voltage-regulator tube (D50), wherein:
the positive electrode (VCC), the second divider resistor (R52), and the third divider resistor (R56) of the battery (6) and the ground compose a loop; the fourth NPN tube (Q51) is conducted, and the first PNP tube (Q50) is subsequently conducted; a voltage between the fourth divider resistor (R53) and the fifth divider resistor (R57) is transmitted to a reference electrode of the voltage-regulator tube (D50); the output voltage Vout of the voltage stabilizing circuit (103)=2.5V*(1+the fourth divider resistor (R53)/the fifth divider resistor (R57)), and the output voltage Vout of the voltage stabilizing circuit (103) supplies power for the power amplifier unit (101).

4. The loudspeaker box for bicycle according to claim 3, wherein the loudspeaker box for bicycle further comprises a loudspeaker protection unit (104), the loudspeaker protection unit (104) comprises a first comparator (U3-A), a second comparator (U3-B), and a relay (KJ1); a sixth divider resistor (R63), a seventh divider resistor (R64), and an eighth divider resistor (R65) that are sequentially connected in series are provided between the output end (VSS) of the voltage stabilizing circuit (103) and the ground; the voltage of a connection point of the sixth divider resistor (R63) and the seventh divider resistor (R64) is transmitted to an in-phase end of the first comparator (U3-A) as a first reference voltage; the voltage of the connection point of the seventh divider resistor (R64) and the eighth divider resistor (R65) is transmitted to an out-phase end of the second comparator (U3-B) as a second reference voltage; the out-phase end of the first comparator (U3-A) and the in-phase end of the second comparator (U3-B) are connected to an input end of the power amplifier unit (101), to enable an audio signal of the input end of the power amplifier unit (101) to be transmitted to the out-phase end of the first comparator (U3-A) and the in-phase end of the second comparator (U3-B); the output end of the first comparator (U3-A) and the output end of the second comparator (U3-B) are connected to the base of a fifth NPN tube (Q60); the emitter of the fifth NPN tube (Q60) is grounded, and the collector of the fifth NPN tube (Q60) is connected to a coil of a relay (KJ1) via a fourth current-limiting resistor (R67); the other end of the relay (KJ1) is connected to the output end (VSS) of the voltage stabilizing circuit (103); one side of a normal-open contact of the relay (KJ1) is connected to the output end of the power amplifier unit (101); and the other side of the normal-open contact of the relay (KJ1) is connected to the loudspeaker (5), wherein:
when the voltage of the audio signal of the input end of the power amplifier unit (101) is lower than the first reference voltage and is higher than the second reference voltage, the first comparator (U3-A) and the second comparator (U3-B) both output the high level, and the fifth NPN tube (Q60) is subsequently conducted, to enable the coil of the relay (KJ1) to be powered and the normal-open contact of the relay (KJ1) to be picked up, and the power amplifier unit (101) is communicated with the loudspeaker (5);
when the voltage of the audio signal of the input end of the power amplifier unit (101) is higher than the first reference voltage, the first comparator (U3-A) outputs the low level, the fifth NPN tube (Q60) is closed, and the power amplifier unit (101) is subsequently disconnected with the loudspeaker (5);
when the voltage of the audio signal of the power amplifier unit (101) is lower than the second reference voltage, the second comparator (U3-B) outputs a low level, the fifth NPN tube (Q60) is closed, and the power amplifier unit (101) is subsequently disconnected with the loudspeaker (5).

5. The loudspeaker box for bicycle according to claim 4, wherein the relay (KJ1) is a relay of an OMRON G6S-2F mini patch.

6. The loudspeaker box for bicycle according to claim 1, wherein the circuit board is further provided thereon with a Bluetooth module (105), the Bluetooth module (105) is electrically connected to the main control unit (100), and the Bluetooth module (105) is used to receive and send a Bluetooth signal.

7. The loudspeaker box for bicycle according to claim 1, wherein the support (2) comprises a clamp (20), an end cap (21), and a universal joint (22); a columnar bearing (23) is formed on the clamp (20), and a bowl-shaped recessed part (28) is formed on the top of the bearing (23); the end cap (21) is disposed on the bearing (23) in a covering manner, and the end cap (21) is provided thereon with a slot (25); the slot (25) extends from the top of the end cap (21) to the side, and the universal joint (22) comprises a spherical part (26) and a connection rod (27); the spherical part (26) is disposed in the recessed part (28), the connection rod (27) penetrates through the end cap (21) and is screwed on the bottom of the housing (1); the side of the bearing (23) is provided with a V-shaped groove (24) surrounding the bearing (23); the side of the end cap (21) is provided and screwed with a top thread (29), and the end part of the top thread (29) is provided in the V-shaped groove (24); and the end part of the top thread (29) is abutted against an inner wall of one side of the V-shaped groove (24) close to the recessed part (28), wherein:
when the top thread (29) is screwed, the end part of the top thread (29) feeds to the V-shaped groove (24) so as to enable, by means of an abutting function of the end part of the top thread (29) and the inner wall of the V-shaped groove (24), the end cap (21) and the bearing (23) to move relatively, until the spherical part (26) is locked in the recessed part (28);
when the top thread (29) is screwed in a reverse direction, the end part of the top thread (29) is away from the V-shaped groove (24), and a gap is generated between the spherical part (26) and the recessed part (28), so that the universal joint (22) can move along the slot (25).
